(19) United States
(12) Patent Application Publication
(10) Pub. No.: US 2002/0164200 A1
(43) Pub. Date: Nov. 7, 2002

(54) Vehicle interior fastener clip assembly for securing a rubber molding between a vehicle dashboard and windshield

(76) Inventor: David Wisniewski, Macomb Twp., MI (US)

Correspondence Address: DOUGLAS J. McEVOY, Gifford, Krass, Groh, Sprinkle,, Anderson & Citkowski, P.C., 280 N. Old Woodward, Suite 400, Birmingham, MI, 48009, US

(21) Appl. No.: 09/834,634

(22) Filed: Apr. 13, 2001

(51) Int. Cl. A44B 21/00; B60R 13/06

(52) U.S. Cl. 403/220; 24/293

(57) ABSTRACT

A fastener clip for securing a rubberized molding in a vehicle interior, the vehicle interior including a windshield and a spaced apart and extending edge of a dashboard assembly. The clip includes a body constructed of a spring steel stamping and having a specified three dimensional and substantially “U” shape with a base, first side and second side. A first pair of inwardly directed prongs extend from the first side and engage a first portion of the rubberized molding and a first location of the dashboard. A second pair of inwardly directed prongs extend from the second side and engage a second location of the dashboard. The fastener clip body affixes the first molding portion of the molding to the extending edge of the dashboard and so that a second extending portion of the molding extends in abutting fashion against a corresponding inner surface of the windshield.

### BACKGROUND OF THE INVENTION

1. Field of the Invention

The present invention relates generally to fastener clips for use in vehicle interior applications. More particularly, the present invention discloses a fastener clip for effectively securing a rubberized trim molding in interposed and abutting fashion between the inner face of the vehicle windshield and the vehicle dashboard.

2. Description of the Prior Art

Vehicle fastener clip assemblies are known in the prior art, particularly those used for securing interior components of the vehicle, such as rubber or plastic moldings associated with the inside dash and/or door, floor and trim moldings, to associated metal surfaces of the vehicle such as defining a part of the vehicle frame. The need for such clip assemblies results from the requirement for securing one type of material to another, again such as applying a plastic or rubber molding to a metal surface. Examples of such conventional clip assemblies are illustrated in U.S. Pat. Nos. 5,722,124 and 6,141,837, both issued to Wisniewski.

An additional type of automotive clip for mounting a radio within a dashboard aperture is illustrated in Gallichan U.S. Pat. No. 5,826,836. The clip has a base with screw for affixing to a side of the component to be mounted. A ram section extends from the base and terminates in a shoulder for spring engagement of the component against an inner surface of the dashboard. A hook on the clip engages a bias hole in a front part when the clip is being affixed to the side of the component for pre-tensioning the ramp section to assist the spring engagement. The clip further includes an aligmnent surface which is dynamically aligned to the reference surface in the front part of the component and while the clip is being affixed to the component. The tension pulls the alignment surface forward against a surface of the component to align the shoulder with respect to the front of the component.

U.S. Pat. No. 6,095,591, issued to Matsuyama et al., teaches an interior material for an automotive vehicle and discloses a front pillar garnish adapted to cover a front pillar disposed between a front windshield and a side door in an automotive vehicle. The front pillar garnish includes a main body section formed of plastic and which is generally channel-shaped. The main body is fixedly connected to the front pillar and located at the side of a passenger compartment. A plurality of generally plate-shaped energy absorbing ribs are integrally formed at the inner surface of the main body section in a manner to be generally perpendicular to the longitudinal axis of the main body section. A plurality of bosses are integrally formed extending from the inner surface of the main body section. A clip supporting member is fixedly secured to the tip end section of the bosses and fixedly supported on the edges of the energy absorbing ribs. A clip is further disclosed and which is formed of a spring material. The clip is fixedly mounted on the clip supporting member and fixable to the front pillar in order to install the front pillar garnish to the vehicle body.

### SUMMARY OF THE PRESENT INVENTION

The present invention discloses a fastener clip for use in a vehicle interior for securing a rubberized molding between the vehicle windshield and extending edge of the dashboard assembly. The fastener clip of the present invention is further an improvement over prior art techniques for securing moldings in place and which are limited to the application of adhesives alone for holding the edge strips or moldings in place. Adhesive applications alone have often been found to be inadequate, particularly when considering the useful life of the application, as well as the temperature and climate ranges which the application must withstand.

The fastener clip includes a body having a specified three dimensional and substantially “U” shape with a base, a first side extending a first predetermined distance, and a second side extending a second predetermined distance greater than the first side. The body is constructed of a spring steel material which is configured into its substantial “U” shape through a stamping operation and further includes a first pair of inwardly directed prongs extending from an extending edge of the first side and which engages a first portion of the rubberized molding and a first location of the dashboard. A second pair of inwardly directed prongs extend from an extending edge of the second side and engages a second location of the dashboard.

An elongate and arcuate configured tang extends inwardly from the second extending side, the tang biases in a first direction against the first portion of the rubberized molding. Upon affixing the fastener and first molding portion upon the dashboard, the tang is deflected in a second and opposite direction, while remaining biased against the molding. A second portion of the rubberized molding extends from the affixed molding in abutting fashion against a corresponding inner surface of the windshield.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the fastener clip according to the present invention;

FIG. 2 is an exploded plan view illustrating the fashion in which the fastener clip engages the rubberized molding upon the extending edge of the dashboard;

FIG. 3 is an assembled view, similar to that illustrated in FIG. 2, and further showing the rubberized molding secured in place and so that a further extending portion of the molding is arrayed in extending and abutting fashion against the inner facing surface of the windshield;

FIG. 4 is a side view of the fastener clip substantially shown in FIG. 1 and illustrating a particular variation of the extending and biasing tang according to the present invention;

FIG. 5 is a front view of a fastener clip according to the present invention and which is a substantial mirror image of the clip previously illustrated in FIG. 1; and

FIG. 6 is a perspective view of the fastener clip also illustrated in the plan view of FIG. 5 and again illustrating the mirrored variation from the clip according to FIG. 1 and in which the second pair of gripping prongs extend in an opposite lateral direction.

### DESCRIPTION OF THE PREFERRED EMBODIMENTS

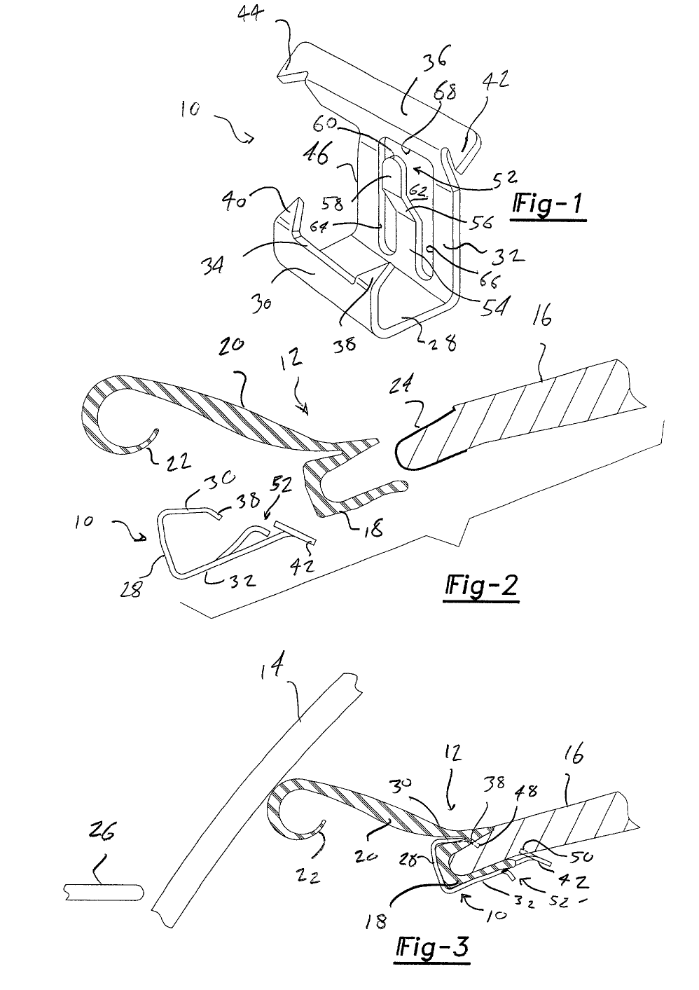

Referring now to FIGS. 1-3, a fastener clip is illustrated at 10 for use in a vehicle interior and for securing a rubberized molding 12 between an inwardly facing surface of a vehicle windshield 14 and an extending edge of the vehicle dashboard assembly 16. The fastener clip according to the present invention is an improvement over prior art techniques for securing any type of trim molding within a vehicle interior and which would be applicable to trim located either along the front windshield, or the side/rear glass surfaces.

The rubberized molding 12 component is conventionally known in the art and can be also constructed of plasticized or other materials. The molding 12 is typically provided as an elongated trim item and, as best illustrated in the cross sectional and cutaway profiles of FIGS. 2 and 3, includes a first portion 18 configured to be seatingly received over the associated edge of the dashboard 16 and upon affixation of the fastener clip 10. The rubberized molding 12 further includes a second extending portion 20 and which extends in a fashion such that a curled and extending edge 22 is in abutting and proximate engagement against the associated inner surface of the vehicle windshield 14 (see FIG. 3).

As best shown in FIG. 2, an adhesive covering 24 may be applied over the forward projecting edge of the vehicle dashboard 16 and which, in use with the fastener clip 10 of the present invention, further enhances the gripping characteristics of the clip 10. It is however understood that the instant invention is the construction and application of the fastener clip 10, it being further understood that the use of such adhesives 24 is intended as an additional or reinforcing benefit to the present clip assembly. Referring further to FIG. 3, an assembled side profile view is shown of the present assembly and also referencing a representative portion of the vehicle hood 26 in relation to the windshield 14, molding 12, clip 10 and dash 16 according to the present invention.

Referring back to FIG. 1, the fastener clip 10 is again illustrated and, according to the preferred variant, is provided as a substantially flat and pre-stamped material constructed of a grade spring steel. The fastener clip 10 exhibits a generally three dimensional shaped body (constructed by the application of an appropriated stamping and bending operation to the preformed blank) and which, according to the preferred variant, includes a substantially “U” shaped configuration with a base 28, a first extending side 30 and a second extending side 32.

In the preferred variant, the first side 30 extends a selected distance from the interconnected base surface 28 and terminates in an extending edge 34. The second side 32 likewise extends a selected and greater distance than the first side 30, in spaced apart fashion, and terminates in a likewise extending edge 36.

A first pair of prongs 38 and 40 extend in a substantially angled/inwardly fashion from the extending edge 34 of the first side 30 and in a direction towards an open interior defined by the substantial “U” shape of the spring clip 10 construction. A second pair of prongs 42 and 44 extend in a substantially opposed and inward fashion from along the extending edge 34 of the second side. As is further best illustrated in FIG. 1, the extending edge 36 of the second side 32 extends laterally beyond an associated side wall (see at 46 in FIG. 1) of the second side 32 and terminates in the second prong 44 of the pair of prongs 42 and 44.

Referring further to the side assembled view of FIG. 3, the “U” shaped configuration of the clip 10 is such that it receives in seating fashion the first portion 18 of the molding 12. Upon affixation to the dashboard 16 edge, the first pair of prongs 38 and 40 pierce through the rubberized molding 12 and a first upper face location 48 (see again FIG. 3) along the dash 16. The second pairs of prongs 42 and 44 engage a further and underside extending edge 50 of the dashboard 16 and so that the second extending portion 20 of the rubberized molding 12 extends in abutting fashion against the corresponding inner surface of the windshield 14.

In this fashion the pairs of prongs 38 and 40 & 42 and 44 exert opposing engaging forces and to prevent inadvertent loosening and/or detachment of the molding 12 from the vehicle dash 16. It is also understood that the use of prongs 38, 40, 42 and 44 is but one application in the present invention, it also being contemplated that differently configured tabs and abutting/engaging portions may be employed and which securably engage the molding 12 to the dash 16 in the fashion desired.

An elongate and arcuate configured tang is illustrated at 52 and which, in FIGS. 1 and 2, extends inwardly from the second extending side 32 in an inwardly biasing manner. As best illustrated in FIG. 1, the tang 52 includes a substantially linear extending base 54, a first inwardly extending portion 56 and a second, reverse bend, and outwardly extending portion 58 which terminates in an upwardly curved and extending edge 60.

The spring steel construction of the fastener clip 10 is further such, upon application of an appropriate cutout operation forming a part of the construction of the clip 10, the tang 52 is configured from material originally associated with the second side 32 of the clip 10 and around the tang 52 is defined a cutout or apertured portion 62 (see again FIG. 1) and around which are defined inwardly extending side 64 and 66 and top 68 edge surfaces of the second side 32.

The tang, upon assembly of the clip 10 and molding 12 upon the dashboard 16 edge in FIG. 3, deflects in a second and opposite direction 52′, and while remaining biased in the initial direction against the first portion 18 of the rubberized molding 12. The tang 52 is therefore configured to provide an additional degree of biasing and retaining force to the molding 12 and against the dashboard edge. Additionally, the features of the material cutout 62 in the second side 32 provides additional spring biasing force, and the laterally projecting location of the prong 44 provides a still further degree of grasping and retaining force to the clip.

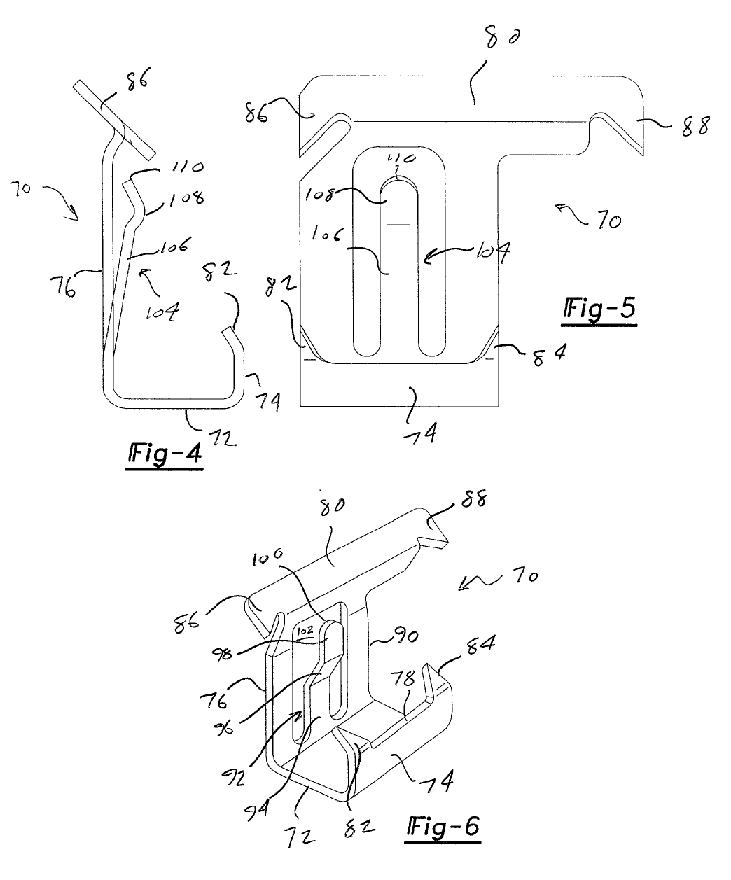

FIGS. 4-6 illustrate respective side, front and perspective views of a fastener clip 70, substantially as shown in FIG. 1 and illustrating a further variation of the extending and biasing tang according to the present invention and which is a substantial mirror image of the clip previously illustrated at 10 in FIG. 1. Specifically, the clip 70 includes each of the features also represented in the clip 10 according to FIG. 1 and including the second pair of gripping prongs with the substantially “U” shaped configuration having a base 72, first extending side 74 and second extending side 76. The first side 72 extends a selected distance from the interconnected base surface 70 and terminates in an extending edge 78. The second side 76 likewise extends a selected and greater distance than the first side 72, in spaced apart fashion, and terminates in a likewise extending edge 80.

A first pair of prongs 82 and 84 extend in a substantially angled/inwardly nfashion from the extending edge 78 of the first side 74 and in a direction towards an open interior defined by the substantial “U” shape of the spring clip 70 construction. A second pair of prongs 86 and 88 extend in a substantially opposed and inward fashion from along the extending edge 80 of the second side 76. As is again illustrated in FIG. 6, the extending edge 80 of the second side 76 also extends laterally beyond an associated side wall (see at 90) of the second side 76 and terminates in the second prong 88 of the pair of prongs 86 and 88.

An elongate and arcuate configured tang is illustrated at 92 in FIG. 6, and extends inwardly from the second extending side 76 in an inwardly biasing manner. As best illustrated in FIG. 6, the tang 92 includes a substantially linear extending base 94, a first inwardly extending portion 96 and a second, reverse bend, and outwardly extending portion 98 which terminates in an upwardly curved and extending edge 100. Around the tang 94 is defined a cutout or apertured portion 102 (see again FIG. 6) and around which are defined inwardly extending side and top edge surfaces of the second side 76.

The mirrored variation of the clip 70, according to FIGS. 4-6, and in which the gripping prongs 86 and 88 extend in the opposite lateral direction relative to those illustrated at 42 and 44 in the embodiment of FIGS. 1-3, is intended in one application to be used in cooperation with the mirrored clip design 10 to hold respective end locations of the molding 12. However, it is also understood that either the variations 10 or 70 can be used interchangeably and as substantially described herein.

Also, the tang can be varied in its configuration, and as illustrated at 104 in FIGS. 4 and 5, such that the colinear base 94, reverse bend 96 and outwardly extending 98 portions are substituted by a generally inwardly extending portion 106 which concludes in an arcuate end portion 108 terminating in a reverse directed edge 110. The tang variation 104 is but one of a number of possibilities of construction in the present design and it is again understood that the fastener clip of the present invention can function to varying degrees with or without the application of the tang.

Having described my invention, additional preferred embodiments will become apparent to those skilled in the art to which it pertains and without deviating from the scope of the appended claims.

I claim:

1. A fastener clip for use in a vehicle interior for securing a rubberized molding between the vehicle windshield and extending edge of the dashboard assembly, said fastener clip comprising:
a body having a specified three dimensional shape and a first gripping means for engaging a first portion of the rubberized molding; and
said body further including a second gripping means, at least one of said first and second gripping means engaging the extending edge of the dashboard and so that a second extending portion of the rubberized molding extends in abutting fashion against a corresponding inner surface of the windshield.

2. The fastener clip as described in claim 1, said body further comprising a substantially flattened and “U” shaped configuration having a base, a first extending side, and a second extending side, said first gripping means extending from said first side and said second gripping means extending from said second side.

3. The fastener clip as described in claim 2, said second side extending a predetermined distance greater than said first side.

4. The fastener clip as described in claim 2, said first and second gripping means further comprising opposing and inwardly directed pairs of prongs.

5. The fastener clip as described in claim 4, further comprising an elongate and arcuate configured tang extending inwardly from said second extending side, said tang biasing in a direction against the first portion of the rubberized molding, said tang being deflected in a second and opposite direction upon affixing said fastener and molding upon the dashboard.

6. The fastener clip as described in claim 5, said fastener clip further comprising a metal stamping, said tang being defined from a cutout portion along said second extending side.

7. The fastener clip as described in claim 1, said body further comprising a substantially flattened and “U” shaped configuration, an adhesive being applied to the extending edge of the dashboard prior to engagement thereto of said body and first rubberized molding portion.

8. The fastener clip as described in claim 5, said tang further comprising a first inwardly extending portion and a second, reverse bend, and outwardly extending portion.

9. The fastener clip as described in claim 1, said body further comprising a substantially flattened and “U” shaped configuration and being constructed of a spring steel material.

10. The fastener clip as described in claim 4, said first pair of prongs projecting from an edge of said first side, said second pair of prongs projecting from an edge of said second side.

11. The fastener clip as described in claim 10, further comprising said edge of said second side extending laterally beyond an associated side wall of said second side, said extending edge terminating in a selected one of said associated pair of prongs.

12. A fastener clip for securing a rubberized molding in a vehicle interior, comprising:
said vehicle interior including a windshield and a spaced apart and extending edge of a dashboard assembly;
said fastener clip including a body having a specified three dimensional and substantially “U” shape with a base, first side and second side; and
a first pair of inwardly directed prongs extend from said first side and engage a first portion of said rubberized molding and a first location of said dashboard, a second pair of inwardly directed prongs extend from said second side and engage a second location of said dashboard;
said body affixing said first portion of said molding to said extending edge of said dashboard and so that a second extending portion extends in abutting fashion against a corresponding inner surface of said windshield.

13. A fastener clip for use in a vehicle interior for securing a rubberized molding between the vehicle windshield and extending edge of the dashboard assembly, said fastener clip comprising:
a body having a specified three dimensional and substantially “U” shape with a base, a first side extending a first predetermined distance, and a second side extending a second predetermined distance greater than said first side;
a first pair of inwardly directed prongs projecting from an edge of said first side and engaging a first portion of the rubberized molding and a first location of the dashboard, a second pair of inwardly directed prongs extending from an edge of said second side and engaging a second location of the dashboard; and
an elongate and arcuate configured tang extending inwardly from said second extending side, said tang biasing in a first direction against the first portion of the rubberized molding, said tang being deflected in a second and opposite direction, upon affixing said fastener and molding upon the dashboard, and so that a second extending portion of the rubberized molding extends in abutting fashion against a corresponding inner surface of the windshield.
